(19) United States
(12) Patent Application Publication
(10) Pub. No.: US 2014/0149663 A1
(43) Pub. Date: May 29, 2014

(54) STORAGE POOLS MANAGEMENT AND/OR PRESENTATION

(71) Applicant: Tonian Inc., Natania (IL)

(72) Inventors: Amit GOLANDER, Tel-Aviv (IL); Yanay Zohar, Tel-Aviv (IL); Danit Segev, Haifa (IL); Douglas O'Flaherty, Reading, MA (US)

(73) Assignee: Tonian Inc., Natania (IL)

(21) Appl. No.: 14/088,478

(22) Filed: Nov. 25, 2013

Related U.S. Application Data
(60) Provisional application No. 61/729,605, filed on Nov. 25, 2012.

(51) Int. Cl. G06F 3/06

(52) U.S. Cl. CPC G06F 3/0689; G06F 3/0619; G06F 3/0665
USPC 711/114

(57) ABSTRACT

A method for presenting a plurality of storage resource pools, comprising: grouping a plurality of quotas of a plurality of storage volumes into at least one of a plurality of storage resource pools according to a plurality of storage volume characteristics technically describing said a plurality of quotas; associating between said plurality of storage volume characteristics and said plurality of storage resource pools; and generating a presentation indicative of said association; and wherein said presentation is presented to a user on a display of an electronic device.

### RELATED APPLICATION

This application claims the benefit of priority under 35 USC 119(e) of U.S. Provisional Patent Application No. 61/729,605 filed Nov. 25, 2012, the contents of which are incorporated herein by reference in their entirety.

### FIELD AND BACKGROUND OF THE INVENTION

The present invention, in some embodiments thereof, relates to storage management and presentation and, more particularly, but not exclusively, to methods and/or systems for managing and/or presenting characteristics of storage pools.

Electronic storage and electronic storage virtualization has undergone a dramatic change over the past few years. Emerging storage technologies such as solid state drives and cloud storage have transformed the storage field. Emerging storage-relevant technologies are related to: storage controllers, data reliability and prevention of data loss, storage efficiency, data capacity reduction techniques, file systems management, parallel access protocols such as parallel network file systems (pNFS), connectivity methods (for example Fiber Channel over Ethernet, (FCoE)) and synchronization/a-synchronization replication.

Popular storage controllers are comprised of Solid State Drive (SSD), SAS, SATA or a mix of those disk types. Different types of storage controllers vary in performance, price, reliability physical location and/or ownership.

For example, storage resources are typically owned and accessed locally or rented and accessed through the internet as in cloud storage. SSD is a data storage device that uses integrated circuit assemblies as memory to store data persistently.

SSD technology uses electronic interfaces compatible with traditional block input/output (I/O) hard disk drives. SSDs do not employ any moving mechanical components, which distinguishes them from traditional magnetic disks such as hard disk drives (HDDs) or floppy disks, which are electromechanical devices containing spinning disks and movable read/write heads. Compared with electromechanical disks, SSDs are typically less susceptible to physical shock, are silent, and have lower access time and latency, but are typically more expensive per unit of storage. Serial-attached Small Computer System Interface is also known as ANSI/INCITS 376-2003 and as Serial-attached SCSI (SAS). SAS is a method for accessing computer peripheral devices that employs serial means of digital data transfer over thin cables. The standard for SAS is provided by the American National Standard Institute. SAS enables business enterprises to access mass storage devices such as external hard drives. Serial ATA also known as Serial AT Attachment (SATA) is an interface for transferring data between host bus adapters to mass storage devices such as hard disk drives and optical drives. SATA was designed to replace the older parallel ATA (PATA) standard offering several advantages over the older interface: reduced cable size and cost, native hot swapping, faster data transfer through higher signaling rates, and more efficient transfer through an (optional) I/O queuing protocol.

Another storage feature is data reliability and prevention of data loss. One technology for preventing data loss is Redundant Array of Independent Disks (RAID). RAID is a storage technology that combines multiple disk drive components into a logical unit. Data is distributed across the drives in one of several ways called “RAID levels”, depending on what level of redundancy and performance (via parallel communication) is required.

Another storage feature is storage efficiency. One technology for promoting storage efficiency is auto-tiering. Auto-tiering is the automated ongoing optimization of data across LUNs or file systems. Basically, data blocks are classified according to their usage. This classification is known as a heat scale with hot being extensive use and cold being minimal use. The hottest data blocks are tiered to higher performance media, while the coldest data is sent to lower cost, higher capacity drives.

Information technology (IT) was traditionally managed in-house, i.e. within a given organization. Cloud services now present alternatives to in-house IT solutions. Emerging representational state transfer (REST) protocols and appliances such as: Amazon S3 gateway and similar gateways and brokers use cloud services. With the development of cloud services the operational expense (OPEX) of IT has cut down. OPEX include the ongoing cost for running a product, business, or system as well as hidden costs of admin hours.

IT, whether in-house, over a cloud or as a combination of both, is typically managed in enterprises and other entities by administrators. Administrators typically play one of the following roles: a virtualization administrator, an application administrator and/or a storage administrator.

### SUMMARY OF THE INVENTION

According to an aspect of some embodiments of the present invention there is provided a method for presenting a plurality of storage resource pools, comprising: grouping a plurality of quotas of a plurality of storage volumes into at least one of a plurality of storage resource pools according to a plurality of storage volume characteristics technically describing the a plurality of quotas; associating between the plurality of storage volume characteristics and the plurality of storage resource pools; generating a presentation indicative of the association; and wherein the presentation is presented to a user on a display of an electronic device.

Optionally, at least one storage resource pool characteristic is at least one of main disk type, RAID type, auto tiering support, deduplication support, compression support, remote copied support, cost per storage capacity, cost per storage Input/Output Operations Per Second (IOPS), QoS service level and SLA service level.

Optionally, the method, further comprises: generating at least one tag representing at least one storage volume characteristic; and associating the at least one tag with at least one of a plurality of storage volumes; wherein the generating at least one tag is performed by at least one of manual tag generation by a user and automatic tag generation by a characteristics discovery module.

Optionally, the grouping a plurality of quotas from at least one of a plurality of storage volumes is performed by at least one of manual grouping by a user and automatic grouping by a grouping module.

Optionally, the method further comprises proposing at least one grouping of a storage volume with at least one storage resource pool according to at least one storage resource pool characteristic and at least one storage volume characteristic.

Optionally, the method further comprises indicating matching at least one storage volume characteristic and the at least one storage resource pool characteristic.

Optionally, the method further comprises: creating at least one binding rule of a storage resource pool wherein the at least one binding rule is defined by at least one of at least one storage volume characteristic and at least one storage resource pool characteristic; and verifying addition of at least one of the plurality of storage volumes to at least one of the plurality of storage resource pools according to the at least one binding rule.

Optionally, the method further comprises: proposing at least one grouping of a storage volume with at least one storage resource pool according to the at least one binding rule of a storage resource pool.

Optionally, the method further comprises: indicating at least one of a match and a mismatch between the storage volume and the at least one storage resource pool.

Optionally, the method further comprises: presenting to a user at least one of the plurality of storage volume characteristics in an electronic device.

Optionally, the method further comprises: allocating the at least one of a plurality of storage resource pools to at least one storage consuming entity according to at least one storage resource pool characteristic; and presenting a plurality of allocations of the at least one of a plurality of storage resource pools to the at least one storage consuming entity.

Optionally, the method further comprises: generating at least one tag representing at least one storage resource pool characteristic; and associating the at least one tag with at least one of the plurality of storage resource pools.

Optionally, generating at least one tag is performed by at least one of manual tag generation by a user and automatic tag generation by a characteristics discovery module.

Optionally, the method further comprises creating at least one binding rule of a storage resource pool wherein the generating at least one tag is inferred from the at least one binding rule of a storage resource pool.

Optionally, generating at least one first tag for a first storage resource pool is deduced from at least one second tag of at least one second storage resource pool wherein the at least one storage resource pool characteristic of the at least one second storage resource pool resembles at least one storage resource pool characteristic of the at least one first storage resource pool.

Optionally, the method further comprises: generating at least one tag according to at least one storage volume characteristic; and associating the at least one tag with at least one of the plurality of storage resource pools; wherein the at least one of a plurality of storage volumes characterized by the at least one storage volume characteristic is grouped with the at least one of the plurality of storage resource pools.

Optionally, associating is performed automatically and at least one of the plurality of storage volumes grouped with the storage resource pool have the at least one storage volume characteristic represented by the at least one tag.

Optionally, at least one storage volume characteristic represented by the at least one tag is unavailable for at least one of the plurality of storage volumes grouped with the storage resource pool.

Optionally, associating is performed automatically and at least one of the plurality of storage volumes grouped with the storage resource pool have at least one of the at least one storage volume characteristic and a stronger version of the at least one storage volume characteristic.

Optionally, at least one tag is generated by calculating a weighted average of first the at least one storage volume characteristic and a second at least one storage volume characteristic.

According to an aspect of some embodiments of the present invention there is provided a computerized method for presenting a plurality of virtual storage pools, comprising: grouping at least one of a plurality of storage resource pools with at least one of a plurality of virtual storage pools according to at least one storage resource pool characteristic; and presenting to a user the at least one virtual storage pool characteristic in an electronic device; wherein the at least one storage resource pool characteristic is grouped with the virtual storage pool and the grouping at least one of a plurality of storage resource pools is at least one of grouping a plurality of quotas from at least one of a plurality of storage resource pools into a plurality of virtual storage pools according to at least one storage resource pool characteristic and designating a plurality of quotas from at least one of a plurality of storage resource pools to a plurality of virtual storage pools according to at least one storage resource pool characteristic.

Optionally, grouping at least one of a plurality of storage resource pools is performed by at least one of manual grouping by a user and automatic grouping by a grouping module.

Optionally, the method further comprises: proposing at least one grouping of a storage resource pool with at least one virtual storage pool according to at least one virtual storage pool characteristic and at least one storage resource pool characteristic; and indicating matching at least one storage resource pool characteristic and the at least one virtual storage pool characteristic.

Optionally, the method further comprises: generating at least one tag according to at least one storage resource pool characteristic; and associating the at least one tag with at least one of the plurality of virtual storage pools; wherein the at least one of a plurality of storage resource pools characterized by the at least one storage resource pool characteristic is associated with the at least one of the plurality of virtual storage pools.

Optionally, the method further comprises: generating at least one tag representing at least one virtual storage pool characteristic; and associating the at least one tag with at least one of the plurality of virtual storage pools wherein the generating at least one tag is performed by at least one of manual tag generation by a user and automatic tag generation by a characteristics discovery module.

Optionally, at least one tag is automatically assigned to a virtual storage pool wherein each of the plurality of storage resource pools grouped with the virtual storage pool have the at least one storage resource pool characteristic represented by the at least one tag.

Optionally, at least one tag represents at least one virtual storage pool simplified characteristic.

Optionally, the grouping at least one of a plurality of storage resource pools groups a plurality of quotas from at least one of a plurality of storage resource pools into a plurality of virtual storage pools according to the at least one virtual storage pool simplified characteristic.

Optionally, generating at least one first tag for a first virtual storage pool is deduced from at least one second tag of at least one second virtual storage pool wherein the at least one virtual storage pool characteristic of the at least one second virtual storage pool resembles at least one virtual storage pool characteristic of the at least one first virtual storage pool.

Optionally, the method further comprises: grouping a plurality of quotas from at least one of a plurality of storage volumes into a plurality of storage resource pools according to at least one storage volume characteristic; and presenting to a user the at least one storage resource pool characteristic in an electronic device; wherein the at least one storage volume characteristic is grouped with the storage resource pool.

Optionally, the method further comprises: allocating the at least one of a plurality of virtual storage pools to at least one storage consuming entity according to at least one virtual storage pool characteristic; and presenting a plurality of allocations of the at least one of a plurality of virtual storage pools to the at least one storage consuming entity.

Optionally, the method further comprises: receiving an allocation request from the at least one storage consuming entity wherein the allocating the at least one of a plurality of virtual storage pools is performed according to the allocation request.

Optionally, the allocation request comprises at least one of a plurality of virtual storage pool characteristics and a plurality of tags representing a plurality of virtual storage pool simplified characteristics and the allocating the at least one of a plurality of virtual storage pools is performed according to at least one of at least one of the plurality of virtual storage pool characteristics and at least one of the plurality of virtual storage pool simplified characteristics.

Optionally, the method further comprises: dissociating the at least one of a plurality of storage volumes from at least one of the plurality of storage resource pools; and updating at least storage resource pool characteristic of the at least one of the plurality of storage resource pools.

According to an aspect of some embodiments of the present invention there is provided a system for presenting and managing storage resource pools of storage volumes, comprising: a user interface module presenting at least one storage resource pool characteristic; and a presentation creation module receiving data about at least one storage resource pool characteristic; and a grouping module grouping quotas from a plurality of storage volumes into at least one of a plurality of storage resource pools.

Optionally, the user interface module enables a user to manage the at least one storage resource pool characteristic.

Optionally, the user interface module enables a user to dynamically group at least one of a plurality of storage volumes into at least one of a plurality of storage resource pools.

Optionally, the system further comprises: a grouping module which is configured to group at least one of a plurality of storage volumes according to at least one storage volume characteristic.

Optionally, the system further comprises: a characteristics discovery module which is configured to detect at least one storage volume characteristic.

According to an aspect of some embodiments of the present invention there is provided a system for presenting and managing virtual storage pools, comprising: a user interface module presenting at least one virtual storage pool characteristic and enabling a user to manage the at least one virtual storage pool characteristic; a presentation creation module receiving data about at least one virtual storage pool characteristic; and a grouping module grouping quotas from at least one storage resource pool into at least one of a plurality of virtual storage pools.

Optionally, the user interface module enables a user to dynamically group at least one of a plurality of storage resource pools into at least one of a plurality of virtual storage pools.

Optionally, the system further comprises: a grouping module which is configured to group at least one of a plurality of storage resource pools according to at least one storage resource pool characteristic.

Optionally, the system further comprises: a characteristics discovery module which is configured to detect at least one storage resource pool characteristic.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data.

Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an illustration of a system for managing, controlling and/or presenting storage resource pools and/or virtual storage pools, according to some embodiments of the present invention;

FIG. 2 is an illustration of a presentation of a storage resource pool, according to some embodiments of the present invention;

FIG. 3 is an illustration of a presentation of storage resource pools presentation along with virtual storage pools presentation, according to some embodiments of the present invention;

FIG. 4 is an illustration of a user interface for grouping storage volumes to storage resource pools, according to some embodiments of the present invention;

FIG. 5 is an illustration of a method for presenting a plurality of storage resource pools, according to some embodiments of the present invention;

FIG. 6 is an illustration of a concurrent presentation of a virtual storage pool and its grouped storage resource pools, according to some embodiments of the present invention;

FIG. 7 is an illustration of a method for presenting a plurality of virtual storage pools, according to some embodiments of the present invention;

FIG. 8 is an illustration of a system for presenting and/or managing storage resource pools and/or virtual storage pools, according to some embodiments of the present invention; and

FIG. 9 is an illustration of user interface for managing entities using quotas virtual storage pools, according to some embodiments of the present invention.

### DESCRIPTION OF EMBODIMENTS OF THE INVENTION

The present invention, in some embodiments thereof, relates to storage management and presentation and, more particularly, but not exclusively, to methods and/or systems for managing and/or presenting characteristics of storage pools.

The complexity of storage management is growing. One result of newly developed storage technologies, such as those listed above in the background section, are larger storage systems with heterogeneous components. The components of such storage systems may even be appliances, such as open-pNFS. System components may differ by version, vendor, optimization point and/or functionality among other features. While large storage systems built of heterogeneous component may be better in many senses and typically cheaper, their management can become more complex. The abundance of storage features also leads to a higher complexity of managing storage systems. Managing complex storage systems require higher skills which usually lead to higher operating expenses (OPEX).

Cloud has driven down storage pricing, pressuring IT administrators to become efficient and reduce its OPEX. IT administrators types, such as storage administrators and virtualization/application administrators, need to know characteristics of the storage they manage to promote efficiency. Lack of storage characteristics information as well as incomplete information, may lead to lower work efficiency, high cost and mistakes. For example, storage administrators occasionally make pooling mistakes.

Different roles within an entity may interact with storage resources: an application administrator, a storage administrator, a virtualization administrator, a system administrator and/or an application end user. Each of these roles may benefit from information about different storage characteristics to improve their work in terms of efficiency, cost etc. Moreover, a different detail level may benefit these different roles. For example: storage administrators may want to know the RAID level (RAID 0, 1, 5, 6, 10, 15, 50 and/or 60), whereas virtualization/application administrators may find this information too detailed, too technical and/or irrelevant for application/virtualization level storage management. Similarly, storage administrators may want to know the storage controller type: SSD, SAS, SATA, a gateway to cloud storage and/or a mix of those disk types, whereas virtualization/application administrators may not understand the performance, price and reliability tradeoff of these different media types. Virtualization/application administrators may require the assistance of storage administrators thereby wasting admin hours. Alternatively, virtualization/application administrators also acquire storage administration skills. The OPEX of these highly qualified administrators are typically higher than administrators with training in one of these storage subfields.

According to some embodiments of the present invention, virtualization/application administrators manage virtual storage pools. Storage resource pools and/or pools of volumes which are grouped according to a user defined requirements are referred to herein as virtual storage pools (vPools) Storage administrators create and export to virtualization/application administrators. vPools group and/or consume storage resources from one or more actual storage resources called storage pools. Storage resource pools may typically group resources of similar, though not necessarily identical storage volumes. vPools, on the other hand, may typically group and/or consume storage resources from heterogeneous storage resource pools according to storage needs of a storage consuming entity.

According to some embodiments of the present invention, storage resource pools group volumes. Tags are associated with the storage resource pools to simplify technical characteristics.

According to some embodiments of the present invention, there are provided methods and/or systems for virtual storage pools management. Actual storage resource pools and/or virtual storage pools, defined below, may improve an administrator's productivity, lower administration OPEX, simplify heterogeneous storage sources usage, and/or improve pooling reliability among other advantages. The characteristics of storage resource pools are presented in a productive manner for virtualization/application administrators, storage administrators and/or other roles. The characteristics of storage resource pools may be presented as tags summarizing their technical characteristics. Tag examples include SATA, RAID 5, Comp (which stands for compression) and Dedup (which stands for de-duplication technology). The tag list may be long and include many tags, as administrators may be interested in a varied and/or complete list of technical characteristics. The characteristics of virtual storage pools are presented in a productive manner for virtualization/application administrators, system administrators and/or organization administrators. The characteristics of virtual storage pools may be presented in user friendly terms summarizing less technical features. For example for: “GOLD Quality of Service”, “5 US dollars per Giga Byte” etc.

Optionally, these tags may contain free text as opposed to closed semantics.

Storage resources often need to be grouped into storage resource pools. Storage resources may include storage volumes and/or storage resource pools. By presenting relevant storage resource pools characteristics, storage resources grouping may be performed more efficiently and more reliably.

Optionally, grouping a plurality of quotas from one or more storage volumes is manually performed by a user (i.e. a storage administrator). Grouping recommendations for a given storage resource may be made.

Optionally, the presented characteristics that describe a storage resource pool may not have been provided by the user. Instead, they or a subset of them may have been auto-deduced from the characteristics of the storage volumes comprising the storage pool.

The characteristics contributing to the match between the storage volumes and the storage pool may be also presented. The change in characteristics of the storage pool after the addition of a new storage volume may also be presented thereby assisting in grouping quotas from storage volumes.

A virtual storage pool may group multiple storage resources which differ from each other by one of more technical characteristics, for instance by the average read latency. Understanding this from the technical characteristics of storage resources may be confusing. The methods and/or systems disclosed herein allow the technical characteristics to be simplified according to the needs of a specific entity.

Optionally, the technical characteristics are simplified in a generic manner regardless of a specific storage consuming entity, and then the storage resource pools and/or the virtual storage pools are matches with a storage consuming entity according to its needs.

The storage characteristics of a storage resource, such as a storage volume, a storage resource pool and/or a virtual storage pool, may be organized in two characteristics sets: a closed characteristic set of defined semantics (for example SSD) and/or an open characteristic set of free text (for example GOLD). The closed characteristic set may include a variable, for example X US Dollars per Giga Byte. X represents in this example an integer number. The closed characteristic set may be useful for storage administrators whereas the open characteristic set may be useful for virtualization/application administrators. Other storage roles may also benefit from one or more of these characteristic sets.

Optionally, storage resource pools are defined according to one or more binding rules. For example, the rule requires that the main disk type is SSD for any volume joining a specific storage resource pool grouped with that binding rule. Attempting to add a storage volume and/or a storage resource pool with one or more volumes of a different main disk type—results in some rejection behavior. The rejection behavior may be a soft warning (e.g. “Are you sure”) or a hard warning preventing the storage unit addition and/or initiating a fixing task.

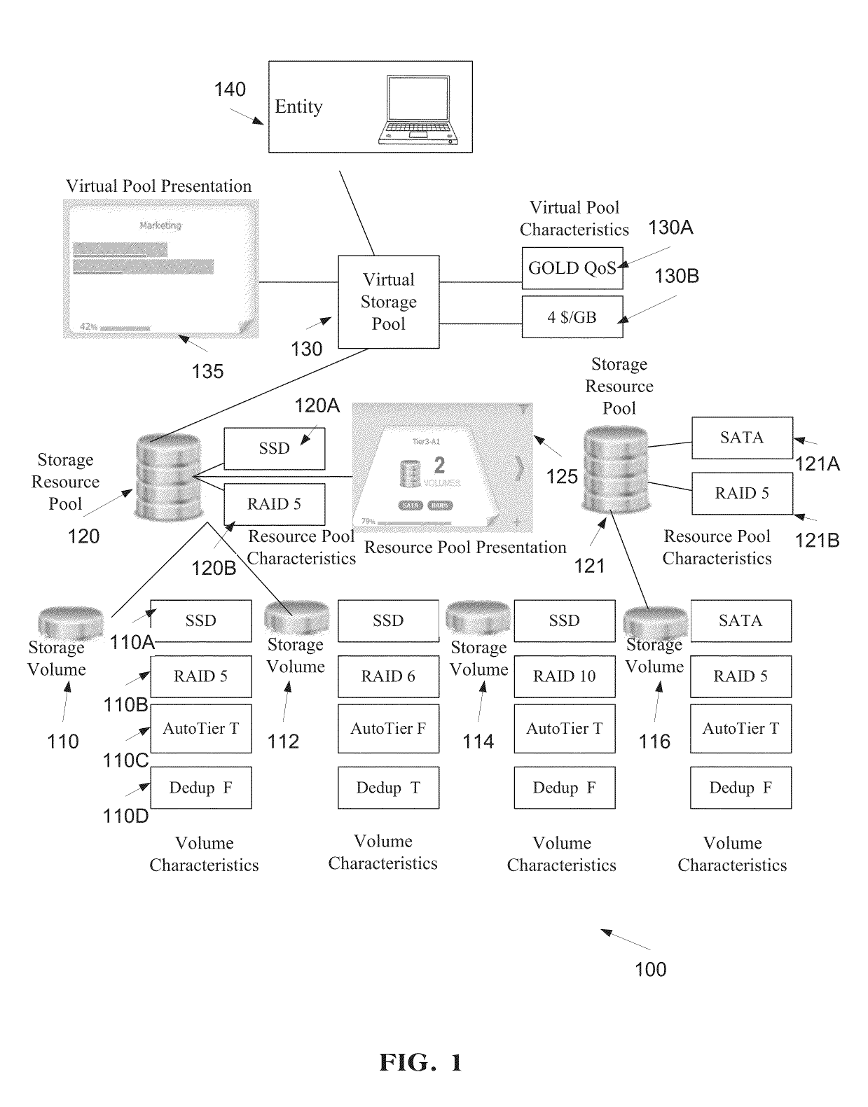

Referring now to the drawings, FIG. 1 illustrates a system 100 for managing, controlling and/or presenting storage resource pools 120, 121 and virtual storage pools 130, according to some embodiments of the present invention. Storage volumes 110, 112, 114, 116 have multiple characteristics such as main disk type, RAID level capacity reduction techniques etc. 110A-110D. The value of each volume characteristic 110A-110D may be chosen from a predefined list. For example, an optional predefined list of values for the main disk type characteristic of a storage volume includes SSD, SAS, SATA and/or Cloud values.

Optionally, such a predefined value list, a subset of that list and/or another modification over that list may also serve a storage resource pool 120, and/or a virtual storage pool 130.

Optionally, a value list of a virtual storage pool 130 may also include generalized less technical terms which may be typically used to characterize a virtual storage pool. These generalized terms may be easier to understand by non-storage administrators. The characteristics 110A-110D of a storage volume may be provided by a characteristics discovery module.

Optionally, storage volume characteristics include free text characteristics such as ˜3 USD per GB.

Optionally, the characteristics discovery module auto-discovers the characteristic of a storage volume 110, 112, 114, 116.

Optionally, storage volume characteristics 110A-110D are automatically provided as a result of an auto-discovery by a characteristics discovery module 825. Here, unlike in traditional mount options, storage volume characteristics 110A-110D may be read as part of listing the available storage volumes appliance 110, 112, 114, 116 for a storage resource pool 120. Proprietary protocols and/or vendor-specific plug-ins, such as for the open source libstoragemgmt library, may be used to extract the information. One optional embodiment of predefined characteristics and their values is provided below as Example 1. In this example, the list is implemented in a Java script object notation (JSON) format. Example 2 illustrates usage of free text characteristics. Example 3 illustrates a combination of predefined characteristics with free text characteristics.

```
Proposed JSON format:
{
  “Version”: 1, # Maintain future flexibility to add values and attributes
    ### 1st section - Fixed attributes and semantics
    “MainDiskType”: <SSD/SAS/SATA/Cloud>,
    “Raid”: <0/1/5/6/10/15/50/60>,
    “AutoTiered”: <true/false>,
    “UseCompression”: <true/false>,
    “UseDedup”: <true/false>,
    “RemotelyCopied”: <true/false>,
    ### 2nd section - Free text attributes
    “Properties”: [ “free text 1”, “free text 2” ]
}
Example 1:
{
  “Version”: 1,
    ### 1st section - Fixed attributes and semantics
    “MainDiskType”: “SAS”
    “Raid”: 5,
    “AutoTiered”: false,
    “UseComp”: false,
    “UseDedup”: false,
    “RemotelyCopied”: false
}
Example 2:
{
  “Version”: 1,
    ### 2nd section - Free text attributes
    “properties”: [“~5 $/GB”, “Silver QoS”, “Bronze SLA”],
}
Example 3:
{
  “Version”: 1,
    ### 1st section - Fixed attributes and semantics
    “MainDiskType”: “SAS”
    “Raid”: 5,
    ### 2nd section - Free text attributes
    “properties”: [“~1 $/IOPS”, “Silver QoS”, “Bronze SLA”],
}
```

Storage volumes 110, 112, 114, 116 are grouped into storage resource pools. Each storage resource pool 120, 121 have storage resource pool characteristics 120A, 120B, 121A, 121B. The storage resource pool characteristics 120A, 120B may be determined based on the storage volumes 110, 112 that are grouped with a specific storage resource pool 120. The number of storage resource pool characteristics 120A, 120B may be smaller than the number of storage volume characteristics 110A-110D. The storage resource pool characteristics 120A, 120B may be a subset of the storage volume characteristics 110A-110D.

Optionally, the types and/or values of storage resource pool characteristics 120A, 120B differ, in part and/or in whole from the types and/or values of the storage volume characteristics 110A-110D.

Optionally, it is desired for a user, such as a storage administrator, to translate the highly-technical storage resource pool characteristics and/or storage volume characteristics into something more intuitive at the storage volume level, the storage resource pool level and/or the virtual storage pool level. The simplified characterizations may assist the virtual storage pool management by the same user and/or by a different user such as an application/virtualization administrator.

Optionally, with lack of a convention, the simplified characterizations may be entity specific. An entity such as 140 may choose to characterize its storage resources and/or storage resource pools in terms such as price and performance metrics, for example “3 United States Dollars (USD) per GB” and “Silver Quality of Service (QoS)” respectively. Another entity may want to emphasize reliability, for instance by adding bronze, silver and gold service level agreement (SLA) characteristics tags, or even an actual variable such as 99.999% availability time.

Optionally, compiling storage resource pools based on multiple storage resource pool characteristics is an automated process. The quotas allocated from each virtual storage pool may be used in this process as well. For example, a virtual storage pool constructed from 25% “8 USD per GB” and 75% “1 USD per GB” is automatically shown as “2.75 USD per GB”. Storage resource pools may be defined, not only by auto-deduced and/or otherwise provided characteristics.

Optionally, the storage resource pool binding rules define a storage resource pool 120, 121. The storage resource pool characteristics 120A, 120B may be determined based on resource pool binding rules. The resource pool binding rules may be defined before, after and/or at the time of grouping one or more storage volumes with a given storage resource pool 120, 121. The resource pool binding rules may be defined regardless of the respective volume characteristics 110A-110D.

Optionally, resource pool binding rules may take into account the storage volume characteristics 110A-110D of storage volumes 110, 112, 114, 116 grouped with the storage resource pool 120, 121. One example of taking storage volume characteristics into account by resource pool binding rules is having resource pool binding rules be bound by the volume characteristic 110A-110D. For example, if a storage resource pool 120, 121 has a SSD volume 110 and a SATA volume 116, a resource pool binding rule cannot require SSD only for that storage resource pool 120, 121.

Optionally, when trying to define such a binding rule in the given storage volume 110,116 setting, a suggestion to lose a storage volume (116) that allows defining that resource pool binding rule would be made. Another example is creating a binding rule before adding storage volumes 110, 112, 114, 116 to a storage resource pool 120, 121. Upon addition of each storage volume 110, 112, 114, 116, its compliance with the binding rule is examined to prevent grouping mistakes.

Optionally, the resource pool binding rule and a non agreeing volume would co-exist and an error handling module 830 would remove such inconsistencies with and/or without manual user intervention. A binding rule associated with a storage resource pool may be defined in terms of storage volume characteristics and/or in terms of storage resource pool characteristics. A binding rule may be defined by a single characteristic and/or by multiple combined characteristics with or without logical relations between them such as if conditions.

A storage resource pool 121 may group one or more storage volumes 116 and have a list of characteristics 121A, 121B. A different storage resource pool 120 may have different storage resource pool characteristics 120A, 120B. The storage resource pool characteristics 120A, 121A and 120B, 121B may be chosen according to the storage needs of a storage consuming entity, application/virtualization administrator requirements, similarity to other storage resource pools 120, 121 etc. Storage resource pools 120, 121 are grouped into virtual storage pools 130. A user interface module 805, presenting and managing virtual storage pools, may assist in this grouping. For example, suggesting to group low-latency and low-cost storage pools with similar reliability level to create a cost-effective virtual storage pool. The assistance of the user interface module 805 may be performed by presenting virtual storage pool characteristics 130A, 130B along with storage resource pool characteristics 120A, 120B, 121A, 121B. The characteristics, simplified characteristics and/or tags of a virtual storage pool 130, may be a weighted average of the characteristics, simplified characteristics and/or tags of the storage resource pools 120, 121 grouped with that virtual storage pool 130. For example, creating a new virtual storage pool by grouping a set amount of quotas from a 2 USD/GB storage resource pool would result in a 2 USD/GB characteristic for the newly created virtual storage pool. Adding the same amount of quotas from a 6 USD/GB storage resource pool to the same virtual storage pool would change that characteristic to 4 USD/GB for that virtual storage pool.

Virtual storage pool characteristics 130A, 130B are associated with each virtual storage pool 130.

Optionally, the virtual storage pool characteristics 130A, 130B are simplified characteristics. Characteristics may be simplified by using common terms instead of technical terms. For example “fast disk” is a simplified version of SAS. Characteristics may be simplified by generalizing terms. For example, “highly reliable” is a simplified version of both RAID15 and RAID6 whereas “medium reliability” is a simplified version of both RAID1 and RAID5. The virtual storage pool characteristics 130A, 130B may be deduced from the respective storage resource pool characteristics 120A, 120B.

Optionally, virtual storage resource pool characteristics 130A, 130B may be defined independently of the respective storage resource pool characteristics 120A, 120B. Upon grouping a storage resource pool 120, 121 with a virtual storage pool 130, the virtual storage pool characteristics 130A, 130B may be compared with the storage resource pool characteristics 120A, 120B. Inconsistencies may prevent the addition of the storage resource pool 120, generate a warning and/or be handled by an error handling module 830.

Storage resource pool characteristics may be used to tag a virtual storage pool with predefined and/or on the fly tags. The content of a tag may be equal to a virtual storage pool characteristic, a virtual storage pool simplified characteristic and/or a generalized virtual storage pool characteristic. On the fly tags may have free text instead of closed semantics. A tag may be manually generated by a user, usually by the storage administrator, who understands and is able to translate the technical characteristics of the constructing storage pools. In some systems, these tags can be used in order to translate the semantics to a specific application/virtualization environment, in which a different terminology is used.

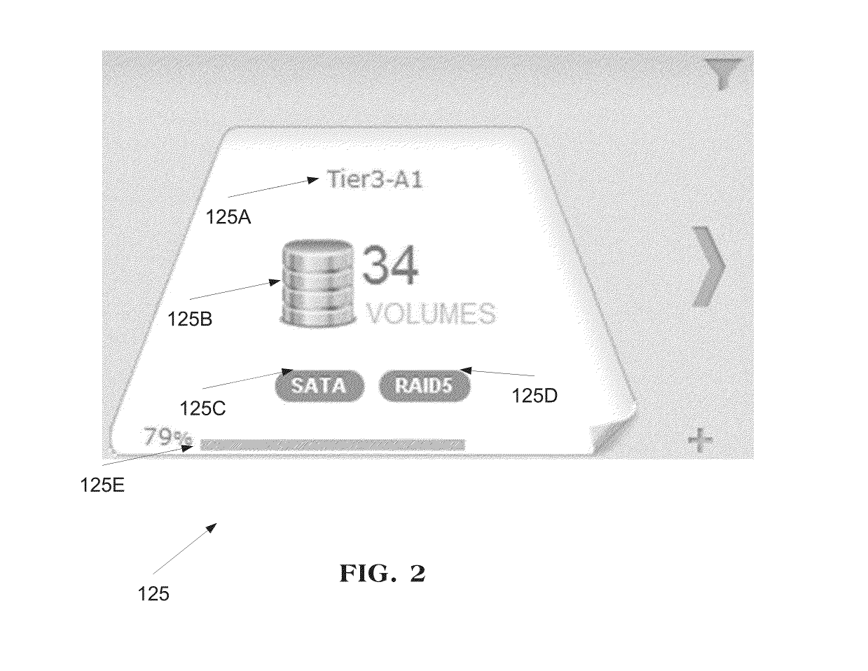

Reference is now made to FIG. 2 which is a graphical presentation of a storage resource pool 120, according to some embodiments of the present invention. A presentation creation module 810 generates a storage resource pool presentation 125. The storage resource pool presentation 125 depicts storage resource pool characteristics 125C-125D of one or more specific virtual storage pool(s) 120. Here, the name 125A, the number of volumes 125B, the main disk type 125C, the RAID level 125D and the usage percentile of existing storage capacity 125E are presented for a given storage resource pool 120. The presented characteristics may be a subset of the storage resource pool characteristics. For example “Compression=False” may not be presented because it is the common scenario and thus only presented when True.

Optionally, the storage resource pool presentation 125 presents tags which represent one or more storage resource pools characteristics 125C-125D. The tags may be manually generated by a user, auto-deduced from the comprising storage volumes and/or a combination thereof.

Optionally, details on the tags of the comprising storage volumes can be viewed as well, for example by flipping the object to its back side, via the lower-right hand corner of the shape.

A storage resource pool characteristic may be inherited from the characteristics of all its comprising storage resources. Often times, though, not all storage resources have known characteristics and even the subset that is known may vary.

Optionally, the presented storage resource pool characteristics are deduced from the respective storage resource pool characteristics and/or the storage volume characteristics. The deduction may be performed according to the following logical rule: |p|<=|P| where P denotes a storage pool with |P| storage volumes, out of which a subset of p volumes hold known characteristics. Depending on the type of attribute, as exemplified below, Att_i is an attribute of P if:
1) All volumes in P share the same attribute (e.g. Att_i(P) if Att_i(v) for every v in P). An example of such an attribute would be “RemotelyCopied”, which is true only if we are certain that all volumes are remotely copied to a disaster recovery site.
2) All volumes in p share the same attribute (e.g. Att_i(P) if Att_i(v) for every v in p). An example of such an attribute would be main disk type, which we may conclude is SSD if all familiar volumes are known to be SSD and the rest are undefined.
3) Most volumes in p share the same attribute (e.g. Att_i(P) if Att_i(v) for most v in p). An example of such an attribute would “Compressed” (UseComp) or “Deduplicated” (UseDedup), which we may conclude is true, if true for most of the familiar, even if not all volumes.
4) All volumes in p share an attribute or a stronger version of that attribute, assuming they may be ordered (e.g. Att_i(P) if Att_i(v) or stronger for every v in p). An example of such an attribute would “RAID”, which we may conclude is 5 (RAID 5 is an efficient protection against single disk errors) if all volumes use RAID 5 or 6 (RAID6 is an efficient protection against dual disk errors). The reason being that RAID5 is the common denominator.

Additionally or alternatively, other variations for deducing storage resource pool characteristics are used. GUI colors, brightness, shade, shape and/or texture may indicate how storage resource pool characteristics is deducted and/or how confident that conclusion is (e.g. is |p|<<|P| or nearly the same size).

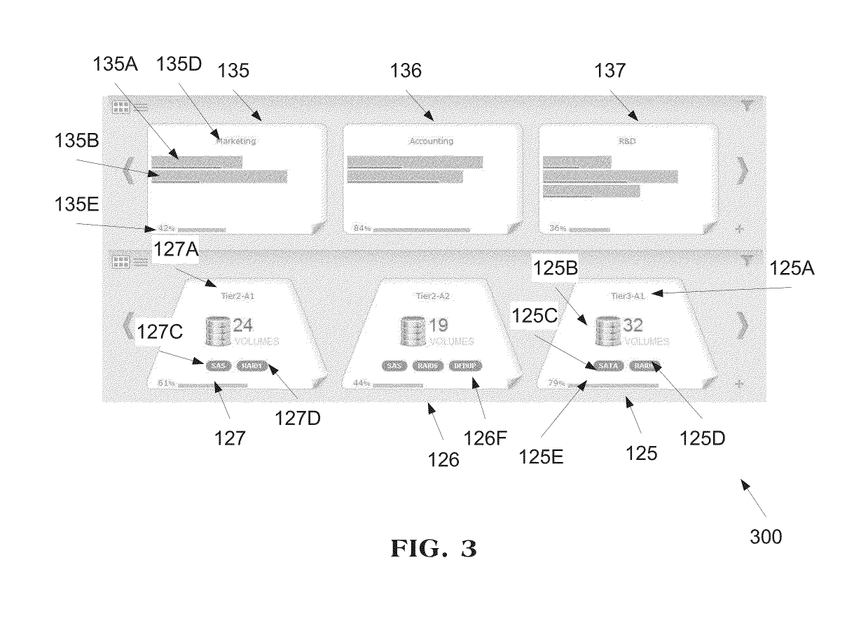

Reference is now made to FIG. 3 that illustrates storage resource pools presentation along with virtual storage pools presentation, according to some embodiments of the present invention. This presentation 300 may be used as a storage administrator view in the user module. The bottom three trapezes are representations of three storage resource pools 125-127. At the top, three rectangles represents three virtual storage pool presentations of three storage consuming entities: marketing 135, accounting 136 and research and development (R&D) 137. In this example, each virtual storage pool presentation 135-137 shows two to three characteristics. The characteristics 125A-125E of the left-hand resource storage pool presentation 125 are as described in FIG. 2. The characteristics 125A-125E describe the set of storage resources 110, 112 that construct storage pool “Tier2-A1” 127, for example, holds 24 volumes, all of which are assumed to use SAS hard drives and are protected with mirroring (RAID1) 127D. The “Tier3-A1” storage pool 125, on the other hand, holds 32 volumes, all of which are assumed to use slower and cheaper SATA hard drives 125C and slower and more cost effective protection (RAID6) 125D. The fact that the left-hand 127 and the right-hand 125 storage resource pools do not present the “Dedup” tag 126F may imply that most of the volumes 110, 112, 114, 116 composing these storage resource pools 120, 121 do not support it.

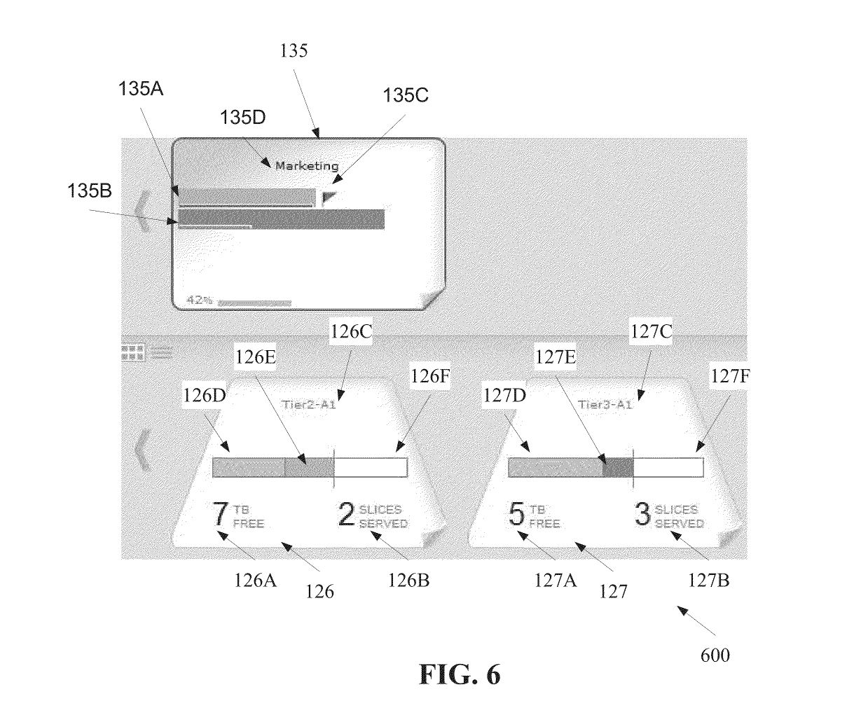

The virtual pool presentations 135-137 may represent different units in the same organization and/or different organizations. The entity identity may be indicated 135D. The correspondence between the virtual storage pools 130 and the storage resource pools 120, 121 may be presented by visually associating the virtual storage pools presentations 135-137 with the storage pools presentations 125-127. The visual association may be indicated, for example, by color, shape, connecting lines, text and/or a combination thereof. Here, the horizontal bars 135A, 135B correspond to the presented storage resource pools 126-127. The horizontal bars 135A, 135B show the usage percentile of each quota from storage pool by that storage consuming entity as presented in 135. FIG. 6 further shows that in some embodiments of the present invention each horizontal bar and the presentation of a storage pool pair (e.g. 135A and 126 or 135B and 127) are colored as visual aid. Summarizing characteristics, summing information over multiple quotas from storage resource pools (presented by 125-127), may also be presented. The characteristics of a virtual storage pool 130 may be different from the characteristics of each of the heterogeneous storage resource pool grouped with it. For example, quotas from two storage pools that do not support auto-tiering (AutoTier=False) can be used in a virtual pool in a way that does support auto-tiering (AutoTier=True).

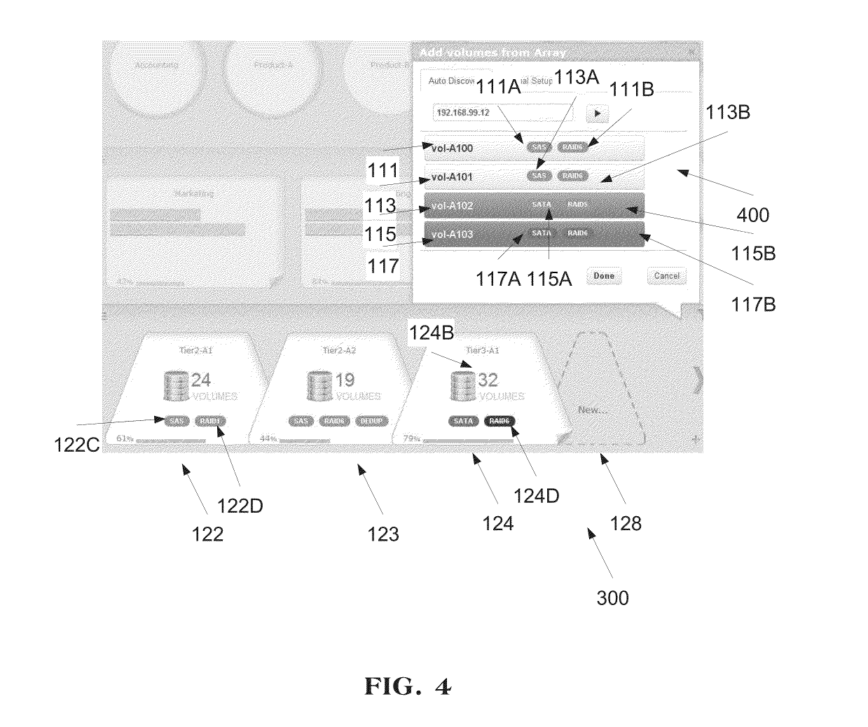

Reference is now made to FIG. 4 which illustrates a user interface 300, 400 for grouping storage volumes to storage resource pools 120, 121, according to some embodiments of the present invention. The user interface 300, 400 enables grouping of storage volumes 110, 112, 114, 116 to storage resource pools 122-124.

Optionally, at least one grouping of a storage volume with at least one storage resource pool is proposed by a grouping module 815. The grouping is proposed according to at least one storage resource pool characteristic 124D and at least one storage volume characteristic 111A, 113A, 115A 117A and 111B, 113B, 115B, 117B.

Optionally, the match between at least one storage volume characteristic 111A, 113A, 115A 117A and 111B, 113B, 115B, 117B and at least one storage resource pool characteristic 124D is indicated.

Optionally, a first storage resource pool 120 is grouped with a second storage resource pool 121. Showing both storage volume characteristics 111A, 113A, 115A 117A and 111B, 113B, 115B, 117B and storage resource pool characteristics 122C-122D in the same presentation 300, 400 at the same time eases the process of grouping storage volumes 111, 113, 115, 117 with one or more storage resource pools 122-124.

Optionally, one or more storage volumes 111, 113, 115, 117 are grouped with a newly created storage pool 128. In this example, it is immediately clear that storage volume vol-A103 117 with its SATA 117A and RAID6 117B tags fits the Tier3-A1 storage resource pool 124 best. In one embodiment, such pooling recommendations are performed automatically and/or on demand by a grouping module 815. The recommendations may be based, for example, on the greatest number of matching storage volume characteristics 111A, 113A, 115A 117A and 111B, 113B, 115B, 117B, and/or calculating a weighted grade of matching storage volume characteristics 111A, 113A, 115A 117A and 111B, 113B, 115B, 117B, giving different weights to different types of storage volume characteristics 111A, 113A, 115A 117A and 111B, 113B, 115B, 117B.

Optionally, color, numerical values, graphs and other presentation schemes are used to mark the level of correlation between a chosen storage resource 111, 113, IR module 115, 117 and a matching candidate virtual storage pool 122-124, 128.

Optionally, storage volumes are grouped first to storage resource pools before grouping into virtual storage pools.

Optionally, storage volumes may be grouped directly into a plurality of different virtual storage pools.

In the example, depicted in 124 and 400, two storage volumes 115, 117 are chosen. Both have a SATA attribute, 115A, 117A which fits the target storage resource pool 124. The two chosen storage volumes 115, 117 are thus marked, for example with a color different from the other storage volumes 111, 113. The chosen storage volumes 115, 117 differ, however, on the RAID level 115B, 117B. The last chosen storage volume 117 is RAID6 117D, which fits the target virtual storage pool 124. The former chosen storage volume 115 is only RAID5. The last storage resource pool characteristic “RAID6” 124D is marked as strike-through, in order to capture a user's attention to the fact that the storage volume 115 may be grouped together with the storage resource pool 124, but at the cost of degrading the storage resource pools' characteristic 124D. If the user chooses to ignore the characteristic mismatch 115B, 124D and continue, he/she sees that the number of volumes increased 124B, and that the concluded attribute 124D has been degraded to RAID5.

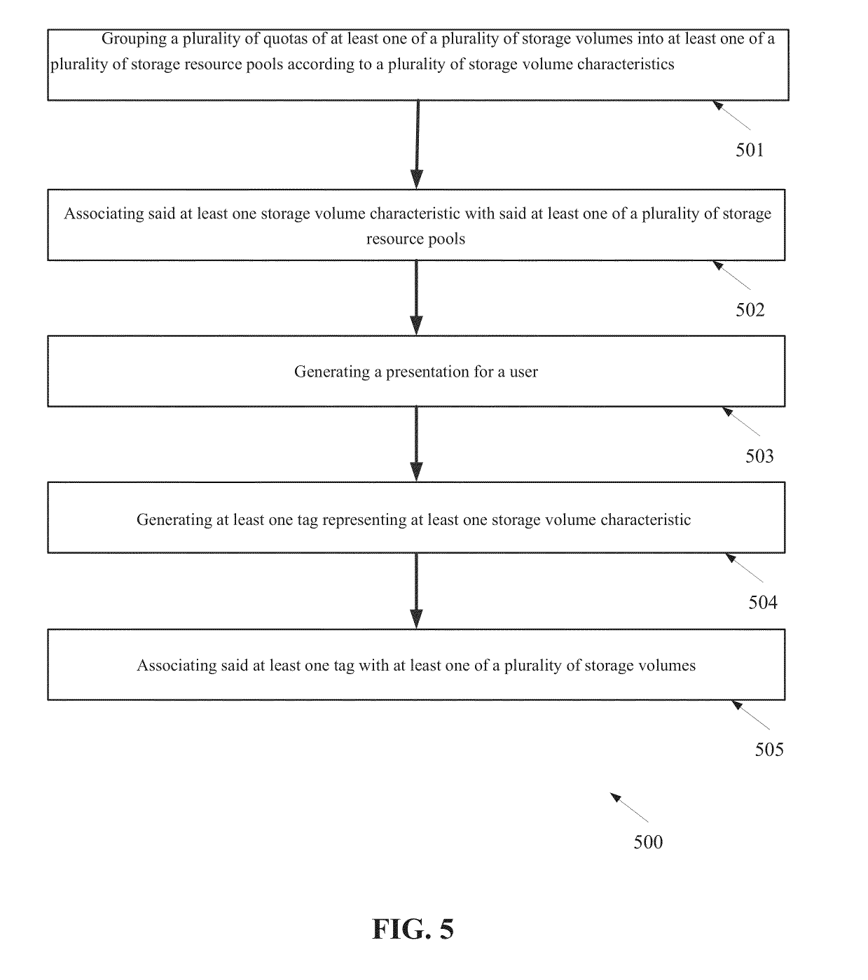

Reference is now made to FIG. 5, which illustrates a method 500 for presenting a plurality of storage resource pools, according to some embodiments of the present invention. First, a plurality of quotas of one or more storage volumes 110, 112, 114, 116 are grouped 501 into one or more storage resource pools 120, 121. Storage volumes may be devices dedicated to storage. Storage volumes may have further applications other than storage such as computing, communication etc. The grouping may be performed according to a plurality of storage volume characteristics 110A-110D, as described in FIG. 2.

Optionally, the grouping is performed according to one or more binding rules associated with a given storage resource pool 120,121. Next, at least one storage volume characteristic 110A-110D is associated 502 with said one or more storage resource pools 120, 121. The associated storage volume characteristic 110A-110D may now function as a storage resource pool characteristic.

Optionally, the associated storage volume characteristic 110A-110D is generalized before functioning as a storage resource pool characteristic. Next, a presentation for a user is generated 503 by a presentation creation module 810. The user may be a general administrator, storage administrator, virtualization administrator, application administrator, information technology (IT) person, a knowledgeable end user, a simple end user etc. The presentation presents at least one storage resource pool characteristic 120A, 121A, 120B, 121B. The storage resource pool characteristics 120A, 121A, 120B, 121B are, for example, main disk type, RAID type, auto tiering support, de-duplication support, compression support, remote copied (for disaster recovery) support, cost per storage capacity, cost per storage TOPS, reliability level, QoS level and/or SLA service level etc.

Optionally, the presentation is presented to a user on an electronic device such as a mobile phone, a terminal, a tablet, a laptop, a desktop, and/or a hand carried portable device.

Optionally, at least one tag representing at least one storage volume characteristic is generated 504. The tag may represent one or more storage resource pool characteristics. The tag may represent one or more storage volume characteristics.

Optionally, a tag is limited to a specific storage resource type such as a storage volume, a storage resource pool or a virtual storage pool.

Optionally, a tag is associated with one or more storage entity types: a storage volume, a storage resource pool and/or a virtual storage pool. A single tag is applied to one or many storage resource pools. The tag may be manually generated by a user. The tag may be automatically generated by a characteristics discovery module 825.

Optionally, at least one tag is associated 505 with one or more storage volumes.

Optionally, a storage resource pool characteristic is deduced according to grouping of one or more storage volumes and/or one or more storage resource pools.

Optionally, the deduction of storage resource pool characteristics is performed automatically by a characteristics discovery module 825. The characteristics discovery module 825 may further be configured to detect characteristics of a storage volume. The characteristics are optionally provided by a user through the user interface module 805.

Reference is now made to FIG. 6, which illustrates a concurrent presentation 600 of a virtual storage pool 130 and its grouped quotas from storage resource pools 126, 127 titled “Tier2-A1” 126C and “Tier3-A1” 127C, according to some embodiments of the present invention. In this example, a virtual storage pool, titled “Marketing” 135D, groups quotas of two storage resource pools. In the presentation of the virtual storage pool 135 the two quotas are indicated with different lines 135A, 135B. The quotas indication and their relative usage are as described in FIG. 3 for presentations 135-137. In each storage resource pool presentation 126, 127, the quota allocated to the “Marketing” virtual storage pool are indicated 126E, 127E. The quotas allocated to storage consuming entities other than the one titled “Marketing” are indicated 126D, 127D. Free quotas of each storage resource pool are also indicated 126F, 127F. These are also summarized numerically 126A, 127A. Allocated quotas are also summarized numerically 126B, 127B. Usage of an allocation quota closed to its limit may be indicated, for example by a flag 135C next to the visual representation of that quota in the virtual storage pool presentation 135.

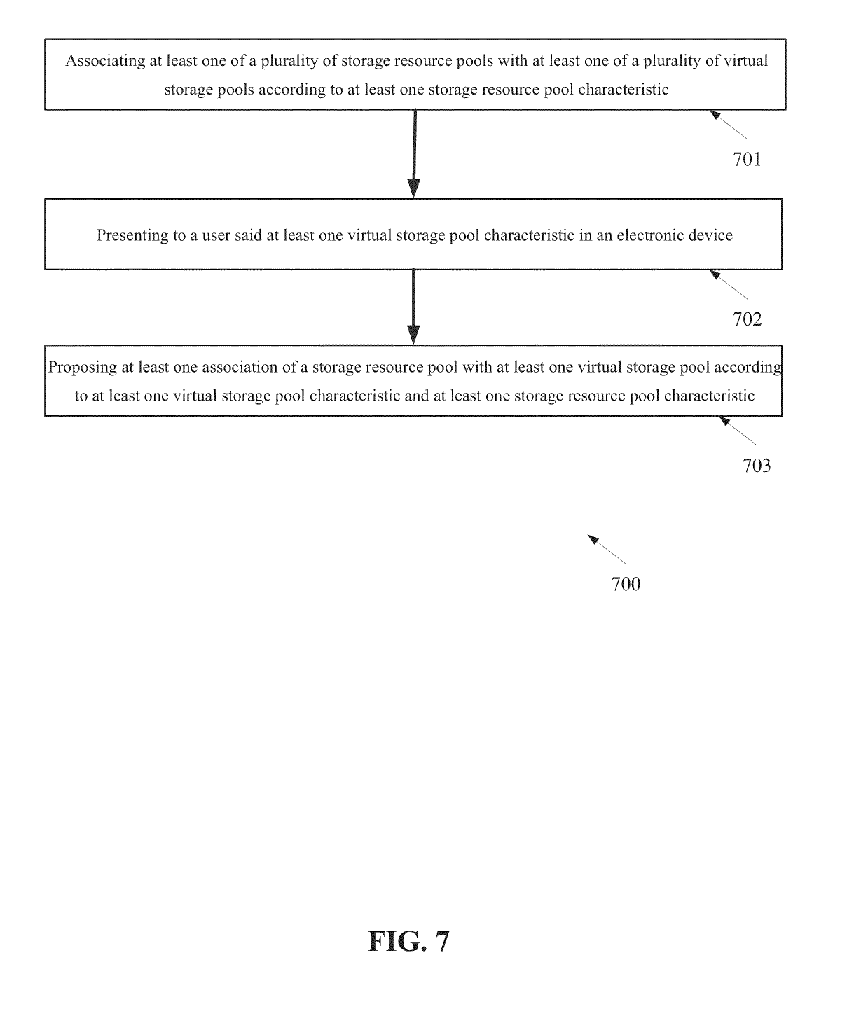

Reference is now made to FIG. 7, which illustrates a method 700 for presenting a plurality of virtual storage pools, according to some embodiments of the present invention. First, as shown at 701, quota from one or more storage resource pools is associated with one or more virtual storage pools. The association is performed according to one or more storage resource pool characteristics.

Optionally, the association is performed according to one or more virtual storage pool characteristics. Next, as shown at 702, at one or more virtual storage pool characteristics are presented to a user in an electronic device.

Optionally, quotas from one or more storage resource pools are grouped with one or more virtual storage pools according to storage resource pool characteristics and/or virtual storage pool characteristics. The grouping may be performed manually by a user and/or automatically by a grouping module 815.

Optionally, the grouping is proposed according to at least one virtual storage pool characteristic and/or at least one storage resource pool characteristic 703.

Optionally, a match between at least one storage resource pool characteristic and one or more virtual storage pool characteristics is indicated.

The shared characteristics of a virtual storage pool may be deduced based on the characteristics of quotas from storage resource pools 120, 121 and/or storage volumes 110, 112, 114, 116 which are grouped with the virtual storage pool. The virtual storage pool characteristics 130A, 130B are displayed in association with the virtual storage pool 130. Virtual storage pools 130 may be allocated to storage consuming entities. The relationships between a virtual storage pool 130 and a storage consuming entity 140 may be presented by the presentation creation module 810.

Optionally, virtual storage pool tags are generated according to one or more storage resource pool characteristics and are associated one or more virtual storage pools.

Optionally, the tag generation and association may be performed automatically. For example since both storage resource pools have similar SLA tags and different QoS tags, some of the storage resource pools 120, 121 associated with a virtual storage pool 130 may not be characterized with respect to a specific storage resource pool characteristic 120A, 120B, 121A, 121B. The virtual storage pool characteristic 130A, 130B may be determined based on the characterized storage resource pools 120A, 120B, 121A, 121B, uncharacterized resource pools and/or both as exemplified with RAID6 in FIG. 4. Quotas from virtual storage pools may be allocated to storage consuming entities. The allocation may be performed as described in FIG. 1.

Optionally, quotas from storage resource pools 120, 121 and/or virtual storage pools 130 are allocated to storage consuming entities application of a user end device 140.

Optionally, the allocation process is initiated by a request from a storage consuming entity 140. The request may include storage requirements. The match between the request and available storage resource pools 120, 121 and/or virtual storage pools 130 may be performed automatically. For example, a user defines that he/she wants a new storage pool with 30 GB quota having a main DiskType of SSD. The user does not specify a specific virtual storage pool and/or a specific storage resource pool. The grouping module 815 may look for such a match using the characteristics specified in the user's request.

Optionally, the storage requirements provided by a user are given in simplified characteristics terms. The simplified characteristics may be translated to the same type of characteristics used to describe the storage resource pools and/or virtual storage pools before matching storage resource pools 120, 121 and/or virtual storage pools 130. For example, a user asks for a new high performance virtual storage pool, which is a simplified characteristic of a virtual storage pool 130, and the grouping module 815 translates that to a request for 30 GB quota having a main DiskType of SSD. The match may proceed as in the previous example. The relationship between virtual storage pools and storage consuming entities may be many to many, one too many and/or one to one. These relationships may be presented to a user. The allocation may be initiated with an allocation request from a storage consuming entity. The allocation request may specify a virtual storage pool, exact characteristics of a virtual storage pool, minimum characteristics of a virtual storage pool, simplified characteristics of a virtual storage pool, tags of a virtual storage pool etc.

Storage resource pools 120, 121 and/or storage volumes 110, 112, 114, 116 which are grouped with a virtual storage pool 130 and/or storage pool 120, 121 may be dissociated from the virtual storage pool 130 and/or storage pool 120, 121. The virtual storage pool and/or storage pool characteristics 130A, 130B, 120A, 120B, 121A, 121B are updated accordingly upon dissociation.

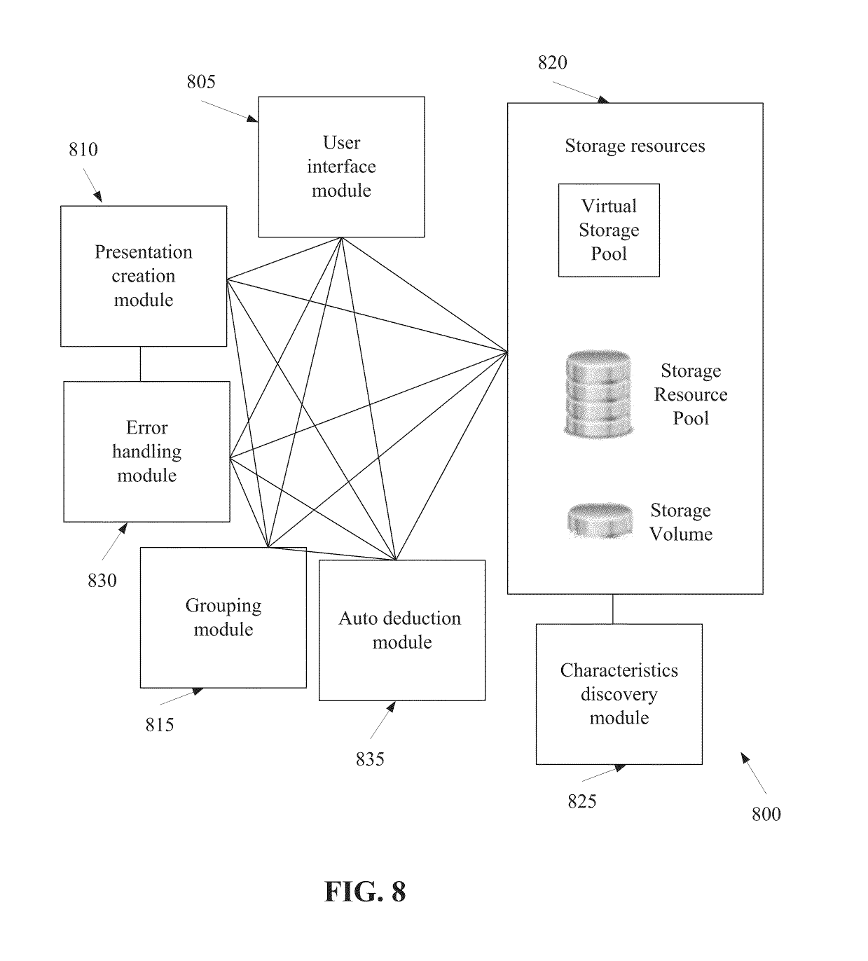

Reference is now made to FIG. 8, which illustrates a system for presenting and/or managing storage volumes, storage resource pools and/or virtual storage pools, according to some embodiments of the present invention. The system 800 is comprised of a user interface module 805, a presentation creation module 810 and a grouping module 815. The presentation creation module 810 receives data about storage resource pool characteristics. The user interface module 805 presents storage volume characteristics, storage resource pool characteristics and/or virtual storage pool characteristics. The user interface module 805 may enable a user to manage storage volume characteristics and/or storage resource pool characteristics and/or virtual storage pool characteristics. The user interface module 805 may enable a user to dynamically group storage volumes into storage resource pools and/or dynamically group quotas from storage resource pools into virtual storage pools. Quotas from heterogeneous storage resource pools may be grouped into virtual storage pools. The grouping module 815 groups quotas from storage volumes with one or more storage resource pools and/or groups quotas from storage resource pools with one or more virtual storage pools. The grouping module 815 may be configured to group storage volumes according one or more storage volume characteristics. The grouping module 815 may be configured to group storage resource pools according to one or more storage resource pool characteristics.

Optionally, the system 800 comprises a characteristics discovery module 825 which detects storage volume characteristics and/or storage resource pools characteristics.

Optionally, the system 800 comprises an auto deduction module 835. The auto deduction module 835 may deduce a first tag for a first storage resource pool 120 based on a second tag of a second storage resource pool 121 if the storage resource pool characteristic(s) of the second storage resource pool resembles the storage resource pool characteristic(s) the first storage resource pool. The auto deduction module 835 may deduce tags for virtual storage pools 130 in a similar manner.

Optionally, each of the system's 800 modules, the user interface module 805, the presentation creation module 810, the grouping module 815 and the characteristics discovery module 825 interacts directly with the storage resources 820, such as a storage volume 110, 112, 114, 116, a storage resource pool 120, 121 and/or a virtual storage pool 130.

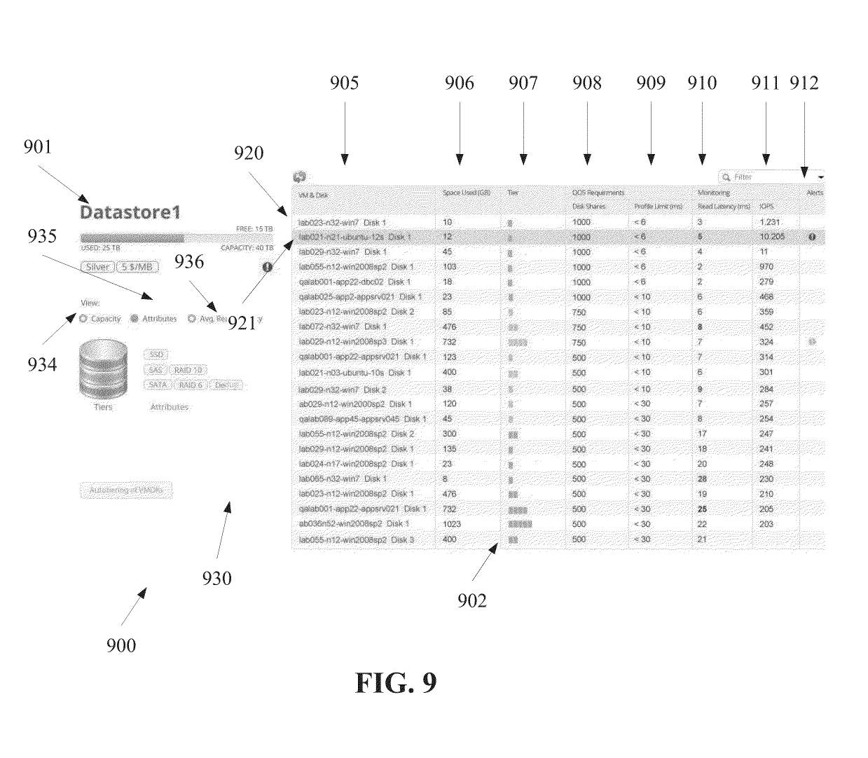

Reference is now made to FIG. 9, which illustrates a user interface for managing entities using quotas from a virtual storage pools, according to some embodiments of the present invention. In this example the user interface 900 displays a Datastore, called “Datastore1” 901, which is an Entity (140), that serves as a Network-Attached Storage (NAS) mount point within VMware virtualization solution (vCenter). Files 920, 921 etc. that are stored within that mount point are called VMDKs (905). In this example the virtual storage pool tags (“Silver” and “5 $/GB”) are displayed along side with the tags of the comprising storage pools (“SSD” for the green tier, “SAS” and “RAID 10” for the yellow tier and so on). Each row in the table 902 represents a file (920, 921) stored in the entity. The color used in column 907 in table 902 indicates which tier (i.e. storage resource pool) is used for storage. Column 905 displays the virtual machine name. Column 906 displays the allocated storage space in Giga Byte units. Column 907 displays the tier level. Here capacity is implied by the number of squares and the tier is displayed by the color of the squares and matches the color scheme presented on the left hand side of table 902. Columns 908, 909 represent the Quality of Service (QOS) requirements. Column 908 displays a prioritization number that is relative to other VMDKs and column 909 represents an absolute limit in milliseconds (ms). Columns 910, 911 represent performance monitoring parameters. Column 910 displays the read latency period in ms. Column 911 displays the Input Output Operations per Second (IOPS). Columns 912 display alerts. The alerts, as well as the latency may be color coded and use bold font to assist an administrator to recognize in a glance items needing his/her attention.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

It is expected that during the life of a patent maturing from this application many relevant storage resource pools, storage volumes and/or virtualization means will be developed and the scope of the terms storage resource pools, storage volumes and/or virtualization means are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for presenting a plurality of storage resource pools, comprising:
grouping a plurality of quotas of a plurality of storage volumes into at least one of a plurality of storage resource pools according to a plurality of storage volume characteristics technically describing said a plurality of quotas;
associating between said plurality of storage volume characteristics and said plurality of storage resource pools;
generating a presentation indicative of said association; and
wherein said presentation is presented to a user on a display of an electronic device.

2. The method of claim 1, wherein said at least one storage resource pool characteristic is at least one of main disk type, RAID type, auto tiering support, deduplication support, compression support, remote copied support, cost per storage capacity, cost per storage Input/Output Operations Per Second (IOPS), QoS service level and SLA service level.

3. The method of claim 1, further comprising:
generating at least one tag representing at least one storage volume characteristic;
associating said at least one tag with at least one of a plurality of storage volumes; and
wherein said generating at least one tag is performed by at least one of manual tag generation by a user and automatic tag generation by a characteristics discovery module.

4. The method of claim 1, wherein said grouping a plurality of quotas from at least one of a plurality of storage volumes is performed by at least one of manual grouping by a user and automatic grouping by an grouping module.

5. The method of claim 1, further comprising proposing at least one grouping of a storage volume with at least one storage resource pool according to at least one storage resource pool characteristic and at least one storage volume characteristic.

6. The method of claim 5, further comprising indicating matching at least one storage volume characteristic and said at least one storage resource pool characteristic.

7. The method of claim 1, further comprising:
creating at least one binding rule of a storage resource pool wherein said at least one binding rule is defined by at least one of at least one storage volume characteristic and at least one storage resource pool characteristic; and
verifying addition of at least one of said plurality of storage volumes to at least one of said plurality of storage resource pools according to said at least one binding rule.

8. The method of claim 7, further comprising proposing at least one grouping of a storage volume with at least one storage resource pool according to said at least one binding rule of a storage resource pool.

9. The method of claim 8, further comprising indicating at least one of a match and a mismatch between said storage volume and said at least one storage resource pool.

10. The method of claim 1, further comprising:
presenting to a user at least one of said plurality of storage volume characteristics in an electronic device.

11. The method of claim 1, further comprising:
allocating said at least one of a plurality of storage resource pools to at least one storage consuming entity according to at least one storage resource pool characteristic; and
presenting a plurality of allocations of said at least one of a plurality of storage resource pools to said at least one storage consuming entity.

12. The method of claim 1, further comprising:
generating at least one tag representing at least one storage resource pool characteristic; and
associating said at least one tag with at least one of said plurality of storage resource pools.

13. The method of claim 12, wherein said generating at least one tag is performed by at least one of manual tag generation by a user and automatic tag generation by a characteristics discovery module.

14. The method of claim 12, further comprising creating at least one binding rule of a storage resource pool wherein said generating at least one tag is inferred from said at least one binding rule of a storage resource pool.

15. The method of claim 12, wherein generating at least one first tag for a first storage resource pool is deduced from at least one second tag of at least one second storage resource pool wherein said at least one storage resource pool characteristic of said at least one second storage resource pool resembles at least one storage resource pool characteristic of said at least one first storage resource pool.

16. The method of claim 1, further comprising:
generating at least one tag according to at least one storage volume characteristic;
associating said at least one tag with at least one of said plurality of storage resource pools; and
wherein said at least one of a plurality of storage volumes characterized by said at least one storage volume characteristic is grouped with said at least one of said plurality of storage resource pools.

17. The method of claim 16, wherein associating is performed automatically and at least one of said plurality of storage volumes grouped with said storage resource pool have said at least one storage volume characteristic represented by said at least one tag.

18. The method of claim 17, wherein said at least one storage volume characteristic represented by said at least one tag is unavailable for at least one of said plurality of storage volumes grouped with said storage resource pool.

19. The method of claim 16, wherein associating is performed automatically and at least one of said plurality of storage volumes grouped with said storage resource pool have at least one of;
said at least one storage volume characteristic; and
a stronger version of said at least one storage volume characteristic.

20. The method of claim 16, wherein said at least one tag is generated by calculating a weighted average of first said at least one storage volume characteristic and a second at least one storage volume characteristic.

21. A computerized method for presenting a plurality of virtual storage pools, comprising:
grouping at least one of a plurality of storage resource pools with at least one of a plurality of virtual storage pools according to at least one storage resource pool characteristic;
presenting to a user said at least one virtual storage pool characteristic in an electronic device; and
wherein said at least one storage resource pool characteristic is grouped with said virtual storage pool and said grouping at least one of a plurality of storage resource pools is at least one of grouping a plurality of quotas from at least one of a plurality of storage resource pools into a plurality of virtual storage pools according to at least one storage resource pool characteristic and designating a plurality of quotas from at least one of a plurality of storage resource pools to a plurality of virtual storage pools according to at least one storage resource pool characteristic.

22. The method of claim 21, wherein said grouping at least one of a plurality of storage resource pools is performed by at least one of manual grouping by a user and automatic grouping by a grouping module.

23. The method of claim 21, further comprising:
proposing at least one grouping of a storage resource pool with at least one virtual storage pool according to at least one virtual storage pool characteristic and at least one storage resource pool characteristic; and
indicating matching at least one storage resource pool characteristic and said at least one virtual storage pool characteristic.

24. The method of claim 21, further comprising:
generating at least one tag according to at least one storage resource pool characteristic;
associating said at least one tag with at least one of said plurality of virtual storage pools; and
wherein said at least one of a plurality of storage resource pools characterized by said at least one storage resource pool characteristic is associated with said at least one of said plurality of virtual storage pools.

25. The method of claim 21, further comprising:
generating at least one tag representing at least one virtual storage pool characteristic;
associating said at least one tag with at least one of said plurality of virtual storage pools; and
wherein said generating at least one tag is performed by at least one of manual tag generation by a user and automatic tag generation by a characteristics discovery module.

26. The method of claim 25, wherein said at least one tag is automatically assigned to a virtual storage pool wherein each of said plurality of storage resource pools grouped with said virtual storage pool have said at least one storage resource pool characteristic represented by said at least one tag.

27. The method of claim 25, wherein said at least one tag represents at least one virtual storage pool simplified characteristic.

28. The method of claim 26, wherein said grouping at least one of a plurality of storage resource pools groups a plurality of quotas from at least one of a plurality of storage resource pools into a plurality of virtual storage pools according to said at least one virtual storage pool simplified characteristic.

29. The method of claim 25, wherein generating at least one first tag for a first virtual storage pool is deduced from at least one second tag of at least one second virtual storage pool wherein said at least one virtual storage pool characteristic of said at least one second virtual storage pool resembles at least one virtual storage pool characteristic of said at least one first virtual storage pool.

30. The method of claim 21, further comprising:
grouping a plurality of quotas from at least one of a plurality of storage volumes into a plurality of storage resource pools according to at least one storage volume characteristic;
presenting to a user said at least one storage resource pool characteristic in an electronic device; and
wherein said at least one storage volume characteristic is grouped with said storage resource pool.

31. The method of claim 21, further comprising:
allocating said at least one of a plurality of virtual storage pools to at least one storage consuming entity according to at least one virtual storage pool characteristic; and
presenting a plurality of allocations of said at least one of a plurality of virtual storage pools to said at least one storage consuming entity.

32. The method of claim 31, further comprising receiving an allocation request from said at least one storage consuming entity wherein said allocating said at least one of a plurality of virtual storage pools is performed according to said allocation request.

33. The method of claim 32, wherein said allocation request comprises at least one of a plurality of virtual storage pool characteristics and a plurality of tags representing a plurality of virtual storage pool simplified characteristics and said allocating said at least one of a plurality of virtual storage pools is performed according to at least one of at least one of said plurality of virtual storage pool characteristics and at least one of said plurality of virtual storage pool simplified characteristics.

34. The method of claim 21, further comprising:
dissociating said at least one of a plurality of storage volumes from at least one of said plurality of storage resource pools; and
updating at least storage resource pool characteristic of said at least one of said plurality of storage resource pools.

35. A system for presenting and managing storage resource pools of storage volumes, comprising:
a user interface module presenting at least one storage resource pool characteristic;
a presentation creation module receiving data about at least one storage resource pool characteristic; and
a grouping module grouping quotas from a plurality of storage volumes into at least one of a plurality of storage resource pools.

36. The system of claim 35, wherein said user interface module enables a user to manage said at least one storage resource pool characteristic.

37. The system of claim 35, wherein said user interface module enables a user to dynamically group at least one of a plurality of storage volumes into at least one of a plurality of storage resource pools.

38. The system of claim 35, further comprising a grouping module which is configured to group at least one of a plurality of storage volumes according to at least one storage volume characteristic.

39. The system of claim 35, further comprising a characteristics discovery module which is configured to detect at least one storage volume characteristic.

40. A system for presenting and managing virtual storage pools, comprising:
a user interface module presenting at least one virtual storage pool characteristic and enabling a user to manage said at least one virtual storage pool characteristic;
a presentation creation module receiving data about at least one virtual storage pool characteristic; and
a grouping module grouping quotas from at least one storage resource pool into at least one of a plurality of virtual storage pools.

41. The system of claim 40, wherein said user interface module enables a user to dynamically group at least one of a plurality of storage resource pools into at least one of a plurality of virtual storage pools.

42. The system of claim 40, further comprising a grouping module which is configured to group at least one of a plurality of storage resource pools according to at least one storage resource pool characteristic.

43. The system of claim 40, further comprising a characteristics discovery module which is configured to detect at least one storage resource pool characteristic.
